(19) United States
(12) Patent Application Publication
(10) Pub. No.: US 2022/0138555 A1
(43) Pub. Date: May 5, 2022

(54) SPECTRAL NONLOCAL BLOCK FOR A NEURAL NETWORK AND METHODS, APPARATUS, AND ARTICLES OF MANUFACTURE TO CONTROL THE SAME

(71) Applicant: Intel Corporation, Santa Clara, CA (US)

(72) Inventors: Lidan Zhang, Beijing (CN); Lei Zhu, Beijing (CN); Qi She, Beijing (CN); Ping Guo, Beijing (CN)

(21) Appl. No.: 17/088,328

(22) Filed: Nov. 3, 2020

(51) Int. Cl. G06N 3/08

(52) U.S. Cl. CPC G06N 3/08

(57) ABSTRACT

Examples methods, apparatus, and articles of manufacture corresponding to a spectral nonlocal block have been disclosed. An example apparatus includes a first convolution filter to perform a first convolution using input features and first weighted kernels to generate first weighted input features, the input features corresponding to data of a neural network; an affinity matrix generator to: perform a second convolution using the input features and second weighted kernels to generate second weighted input features; perform a third convolution using the input features and third weighted kernels to generate third weighted input features; and generate an affinity matrix based on the second and third weighted input features; a second convolution filter to perform a fourth convolution using the first weighted input features and fourth weighted kernels to generate fourth weighted input features; and a accumulator to transmit output features corresponding to a spectral nonlocal operator.

### FIELD OF THE DISCLOSURE

This disclosure relates generally to neural networks and, more particularly, to a spectral nonlocal block for a neural network and methods, apparatus, and articles of manufacture to control the same.

### BACKGROUND

A neural network typically includes multiple layers of nodes, which include an input layer, one or more intermediate layers, and an output layer of the neural network, also referred to as the classification layer of the neural network. The training of the neural network typically includes varying the node weights in the layers of the neural network to meet a classification performance target. Some neural network initialization techniques focus on maintaining the magnitudes of the weights of the layers within a target range, which helps ensure convergence of the neural network.

### BRIEF DESCRIPTION OF THE DRAWINGS

FIG. 1 is a block diagram illustrating an example neural network implemented in accordance with teachings of this disclosure.

FIG. 2 is a block diagram of the example full-scale spectral nonlocal block of FIG. 1 that could be implemented as a layer of the neural network of FIG. 1.

FIGS. 3A and 3B are flowcharts representative of example computer readable instructions that may be executed to implement the full-scale spectral nonlocal block of FIG. 1 to convert input features into output features as part of a convolution layer.

FIG. 4 is a block diagram of an example processor platform structured to execute the example instructions of FIGS. 3A and 3B to implement the example full-scale spectral nonlocal block of FIG. 2.

The figures are not to scale. In general, the same reference numbers will be used throughout the drawing(s) and accompanying written description to refer to the same or like parts, elements, etc.

Descriptors “first,” “second,” “third,” etc., are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

As noted above, a neural network typically includes multiple layers of nodes, which include an input layer, one or more intermediate layers, and an output layer of the neural network, also referred to as the classification layer of the neural network. The training of the neural network includes varying the node weights in the layers of the neural network to meet a classification performance target. Neural networks (e.g., convolutional neural networks (CNNs), deep neural networks, etc.) are increasingly used in many fields including computer vision tasks. Traditional neural networks have a limited field of view in classifying data, which hinders long-range dependencies of rich, structured information used in computer vision tasks. Long range dependencies correspond to a rate of decay of statistical dependence of two points with increasing time interval or spatial distance between the two points. Some neural networks include convolutional layer(s) that focus on a small section of input data (e.g., a 3 by 3 kernel of an image). In such neural networks, a larger receptive field can be obtained by stacking multiple convolution layers. However, stacking multiple layers creates a damping effect caused by interference between a large number of positional pairs. Examples disclosed herein utilize the full range of input data (e.g., an image) to avoid stacking deeper layers, thereby resulting in a flexible layer that avoids the damping effect caused by the interference between the large number of positional pairs of traditional techniques.

To capture long-range dependencies for related data (e.g., one or more images captured by an image and/or video sensor), nonlocal blocks have been introduced into neural networks to create a dense affinity matrix that includes a relation between every pairwise position and use the affinity matrix as an attention map to aggregate features. However, such nonlocal blocks diminish the differentiated features due to a damping effect resulting from an interference between the large number of position pairs. Examples disclosed herein include an efficient nonlocal block including a spectral nonlocal block (SNL) and/or a general SNL (gSNL). The nonlocal block disclosed herein can be inserted into neural network backbones (e.g., as a plug and play component) to capture long-range dependencies with better efficiency than traditional nonlocal blocks.

Examples disclosed herein process a full range of the input data to provide increase efficiency in object detection, segmentation, etc. Although interference increases as the range of the input data increases, examples disclosed herein achieve better context encoding by processing a full-range of dependencies while suppressing the interference using the SNL and gSNL blocks. Accordingly, examples disclosed herein utilize a SNL block and a gSNL block to process a full-range of dependencies using a 1^{st} order and/or a full-order Chebyshev polynomials to approximate a filter of a fully-connected graph that can be implemented in existing models. The examples disclosed herein achieve better performance in multiple computer vision tasks including image/video classification compared to prior models.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a neural network model is used. In general, machine learning models/architectures that are suitable to use with the example approaches disclosed herein include neural network based models (e.g., convolution neural networks (CNNs), deep neural networks (DNNs), etc.). However, other types of machine learning models could additionally or alternatively be used, such as deep learning and/or any other type of AI model.

In general, implementing an ML/AI system involves two phases, a training phase (also referred to as a learning phase) and an inference phase. In the training phase, a training algorithm is used to train a model to operate in accordance with patterns and/or associations based on, for example, training data, also referred to herein as training samples. In general, the model includes internal parameters that guide how input data is transformed into output data, such as through a series of nodes and connections within the model to transform input data into output data. In some examples, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses training samples that include inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using any training algorithm and/or any type of training data. In examples disclosed herein, training is performed until an acceptable amount of error is achieved. Training is performed using hyperparameters that control how the learning is performed (e.g., a learning rate, a number of layers to be used in the machine learning model, etc.). In some examples, re-training may be performed. Such re-training may be performed in response to obtaining additional training data, for example.

In some examples, training is performed using training data. Because supervised training is used, the training data is labeled. Labeling is applied to the training data by an audience measurement entity, a server, and/or a human.

Once training is complete, the model is deployed for use as an executable construct that processes an input and provides an output based on the network of nodes and connections defined in the model. The model may be stored locally or remotely. The model may then be executed by a model generator or other device to perform classifications of input data.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what the AI model learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed AI model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

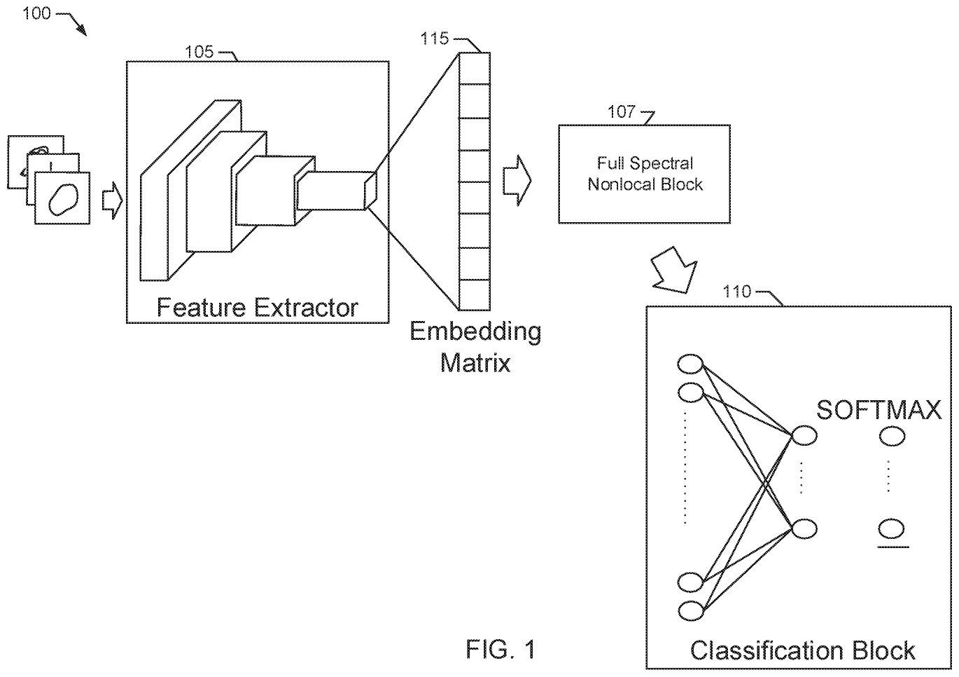

FIG. 1 illustrates an example neural network 100 implemented in accordance with teachings of this disclosure. The example CNN 100 of FIG. 1 includes an example feature extraction block 105, an example full spectral nonlocal block 107 (e.g., corresponding to the SNL and/or the gSNL), and an example classification block 110 (also referred to as an example classification layer 110 or a classifier 110). The example neural network 100 of FIG. 1 is illustrated as a convolutional neural network (CNN). Alternatively, the neural network 100 may be any type of AI model.

The feature extraction block 105 of FIG. 1 receives (e.g., obtains) an input data to be classified, such as an input image. The feature extraction block 105 applies a series of convolutions and pooling operations with the goal of identifying discriminative features. The output of the feature extraction block 105 is an example feature matrix 115 (e.g., a classification vector or matrix corresponding to a width (W), a height (H), and a number of channels (C)) that includes N features representing the input data. As such, the example feature matrix 115 is also referred to as the feature encoding or feature embedding of the input data. For example, if the input data is an image, the feature matrix 115 can be considered to be the image encoding or embedding of the image. If the example feature extraction block 105 is well trained using a balanced dataset, encodings for data from the same class should be sufficiently similar in value to represent the same feature. FIG. 1 illustrates an example of the distribution of this feature matrix 115 for the case of 10-dimensional feature matrices determined for respective input images. The respective feature matrix 115 for each input data (e.g., each input image) is the input to the classification block 110.

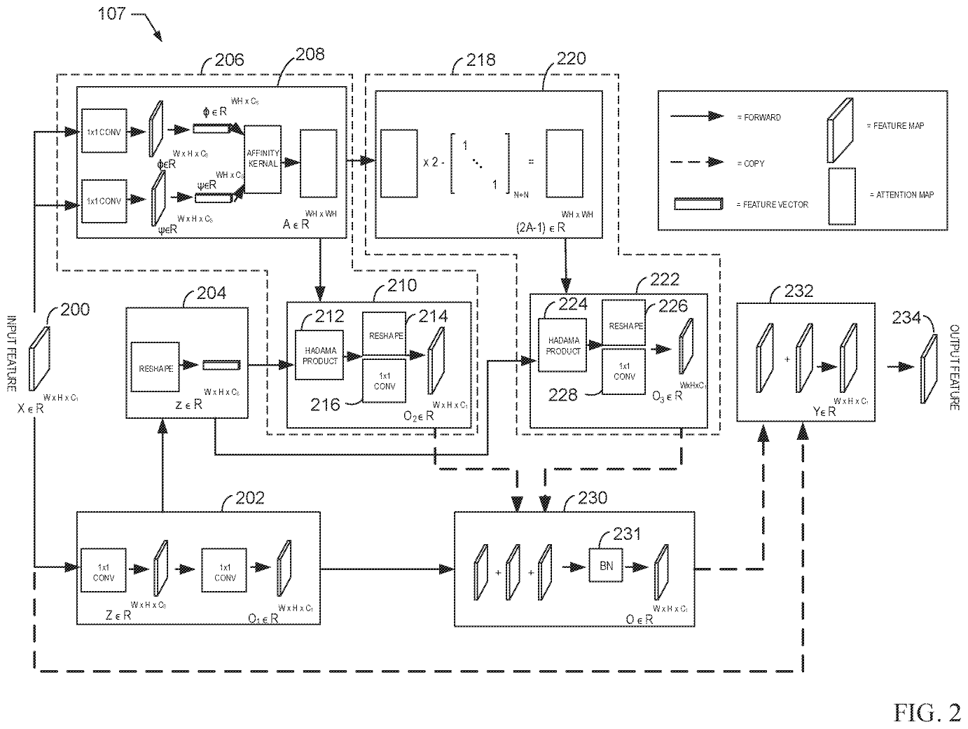

In the illustrated example of FIG. 1, the output of the feature extractor 105 (e.g., the embedding matrix 115) is transmitted to the full spectral nonlocal block 107. Alternatively, one or more of the layers of the example feature extractor 105 may include and/or may be replaced by the full spectral nonlocal block 107. The example spectral nonlocal block 107 captures long-range spatial/temporal dependencies between spatial input data (e.g., spatial pixels, temporal frames, etc.) using a fully-connected graph (e.g., all the input features) approximated by Chebyshev polynomials. In this manner, the spectral non local block 107 is able to capture long-range spatial/temporal dependencies while reducing interference without the amount of computation and/or memory cost of traditional nonlocal blocks. The example spectral nonlocal block 107 outputs an output feature map to a subsequent layer (e.g., when the spectral nonlocal block 107 is implemented in a layer of the feature extractor block 105) and/or the classifier block 110. The example spectral nonlocal block 107 is further described below in conjunction with FIG. 2.

The example classification block 110 of FIG. 1 receives (e.g., obtains) the output features (e.g., an embedding matrix) from the full spectral nonlocal block 107 and classifies the output features by calculating the probabilities of the output features belonging respective ones of the possible output classes. In some examples, the classification block 110 classifies the output features into the class having the largest classification probability among the possible output classes. During training, the CNN 100 is trained to optimize a loss function through back-propagation and gradient descent. One of the most common objective functions is the cross-entropy loss, which measures the difference between the predicted distribution f(x) and the target distribution, p(s) (e.g., constructed from ground truth). There may be two pathways to reduce the loss according to the blocks of the network: by updating the parameters of the backbone (e.g., the feature extraction block), or by updating the parameters of the classifier block. A backbone update includes updating parameters of the convolution filters of the network, eventually leading to different encode vectors. From the geometric perspective, in order to reduce the loss, the network can reduce an angle θ_{c}ⁱ (e.g., the angle between the image encoding (i) with respect to a classifier vector c) by moving the encoding to be sufficiently similar in value to the corresponding classifier. A classifier update includes updating the example classifier block 110 by updating the classifier's vectors. The training process may yield an increase of |W_{C}| (e.g., a filter matrix) for the correct class and/or change the direction of the vector, so the angle θ_{c}ⁱ of the correct class is reduced. Likewise, it can also reduce the norm of the rest of the classifiers and/or increase their angles with the encoding by changing their directions away from it.

The example feature extraction block 105 of FIG. 1 is structured to update the parameters of the convolutional filters with the goal of reducing the distances between feature matrices 115 from the same class and increasing the distances between feature matrices 115 from different classes. The example classification block 110 is trained by updating the classification vectors of the classification block 110. For example, the training process can yield changes in the norm (e.g., magnitude) of the classifier vectors (relative to the origin in the N-dimensional classification space) and/or changes in the direction of the classifier vectors (relative to the origin in the N-dimensional classification space), so the angles between the feature matrices 115 and the correct classification vectors for those feature vectors are reduced.

The example classification block 110 of FIG. 1 may be a classifier with a softmax function. A softmax function is a function that obtains a vector of N real numbers, and normalizes the vector into a probability distribution consisting of N probabilities proportional to the exponentials of the input numbers. In some examples, the classification block is composed of several dense layers. In some examples, the classification block may be the last layer, or output layer, or classification layer of a neural network. The classification layer calculates the class probability for the input data. As described above, the example classification block 110 also uses a softmax function, which is a non-linear transformation that produces a probability distribution across all classes. The performance of the classifier block may be dependent upon the quality of the features. Accordingly, the classifier may benefit from well-separated class-wise features.

FIG. 2 is a block diagram of an example implementation of the full spectral nonlocal block 107 of FIG. 1. The full spectral nonlocal block 107 of FIG. 2 includes example input features 200, example convolutors (e.g., also known as convolution filters) 202, 216, 228, example reshapers 204, 214, 226, an example spectral nonlocal block 206, an example affinity matrix generator 208, an example affinity matrix applicator 210, example multipliers 212, 224, an example full-order spectral nonlocal block 218, an example Chebyshev matrix approximator 220, an example Chebyshev matrix applicator 222, example accumulators 230, 232, an example bin normalizer 231, and example output features 234. Although the illustrated example full spectral nonlocal block 107 includes both the example spectral nonlocal block 206 and the example full-order spectral nonlocal block 218, in other examples, the example full spectral nonlocal block 107 may only include the spectral nonlocal block 206.

The example input features 200 of FIG. 2 are provided in a feature map (e.g. a matrix) that includes data corresponding to an input image. The example input features 200 may be from the output of the feature extractor 105 (FIG. 1) or from one or more layers of the feature extractor 105. In some examples, the input features 200 correspond to the embedding matrix 115 of FIG. 1. The input features 200 (e.g., X) belong to the set of real numbers defined by a width (W), a height (H), and a channel (C₁) (e.g., X∈R^{W×H×C1}). The example input features 200 are input into the example convolutor(s) 202, the example affinity matrix generator 208, and the example accumulator 232.

The example convolutor(s) 202 of FIG. 2 perform(s) a first 1×1 convolution operation using weighted kernels (e.g., which are determined during training of the example neural network 100) to generate first weighted input features (e.g., Z∈R^{W×H×Cs}). The example convolutor(s) 202 output(s) the first weighted input features (Z) to the example reshaper 204. The example reshaper 204 converts the three-dimensional first weighted input features into reduced first weighted input features by reducing the dimensions of the three-dimensional first weighted input feature to two dimensions (e.g., z∈R^{WH×Cs}) and outputs the two dimensional first weighted input features to the example affinity matrix applicator 210. Additionally, the example convolutor(s) 202 of FIG. 2 perform(s) a second 1×1 convolution operation using weighted kernels to generate fourth weighted input features (e.g., 0₁∈R^{W×H×C1}). The example convolutor(s) 202 may be implemented as one convolutor (e.g., to perform both the first and second convolutions) or separate convolutors (e.g., a first convolutor to perform the first convolution and a second convolutor to perform the second convolution). The example convolutor(s) 202 output(s) the fourth weighted input features (0₁) to the example accumulator 230.

The example affinity matrix generator 208 of FIG. 2 generates the affinity matrix A based on the example input features 200. For example, the affinity matrix generator 208 may use the second weighted input features and the third weighted input features based on a dot product (e.g., A=(XW_{θ})(XW_{φ})^{T}=(ϕ)(ψ)^{T}, where A is the affinity matrix, X is the input features 200, W_{θ} and W_{φ} are respective weighted kernels, ϕ is reshaped using second weighted input features, and ψ is reshaped using third weighted input features). Accordingly, the affinity matrix generator 208 may perform a second 1×1 convolution operation (e.g., using a first convolution filter) using weighted kernels (e.g., which are determined during training of the example neural network 100) to generate second weighted input features (e.g., ϕ∈R^{W×H×Cs}). Additionally, the affinity matrix generator 208 of FIG. 2 performs a third 1×1 convolution operation (e.g., using the first convolution filter or a second convolution filter) using weighted kernels (e.g., which are determined during training of the example neural network 100) to generate third weighted input features (e.g., ψ∈R^{W×H×Cs}). The example affinity matrix generator 208 reshapes (e.g., using a reshaper) the second and third weighted input features into two dimensions (e.g., ϕ∈R^{WH×Cs} and ψ∈R^{WH×Cs}) and performs the above-referenced calculation (e.g., using a multiplier) to generate the affinity matrix (e.g., A=(ϕ)(ψ)^{T}). In other examples, the affinity matrix generator 208 may use the input features 200 to determine the affinity matrix using a Gaussian kernel approach (e.g., A=exp(−XX^{T})). The example affinity matrix generator 208 may determine the affinity matrix based on any alternative manner. The example affinity matrix generator 208 outputs the affinity matrix (A∈R^{WH×WH}) to the example matrix applicator 210 of FIG. 2.

The example matrix applicator 210 of FIG. 2 generates a fully-connected weighted graph, G=(V, Z; E, A), where V is a node set where the nodes represent respective positions of the input feature map, Z represents the first weighted input features, E is the edges connected to node pairs, and A is the weight of the edges (e.g., the affinity matrix). The example matrix applicator 210 defines the graph spectral domain of G using the eigenvalue Λ and eigenvector U of the graph Laplacian: L=D−A=U^{T}ΛU, where D=diag(d) is the diagonal degree matrix of A. Then a graph filter approximated by the 1^{st}-order Chebyshev polynomials is defined by the example matrix applicator 210 on the graph spectral domain to refine the node feature X, as shown below in conjunction with Equation 1.

F(A,Z)=O₁+O₂ (Equation 1)

In Equation 1, O₁ is the output of the example convolutor 202 (e.g., the fourth weighted input features) and O₂ is the output of the affinity matrix applicator 210 (e.g., a connected graph). The example accumulator 230 generates the 1^{st} order Chebyshev polynomials defined in Equation 1 by summing O₁ and O₂, as further described below.

To generate O₂, the example matrix multiplier 212 of the matrix applicator 210 of FIG. 2 multiplies the output of the example reshaper 204 (e.g., the reduced dimension first weighted input features) with the output of the example affinity matrix generator 208 (e.g., the affinity matrix, A) to generate an affinity product. The example reshaper 214 reshapes the product into three dimensions (e.g., (z)(A) ∈R^{W×H×C1}). Additionally, the convolutor 216 of FIG. 2 performs a 1×1 convolution operation using weighted kernels to generate the connected weighted graph (e.g., O₂ E R^{W×H×C1}). The example accumulator 230 adds the connected weighted graph with the fourth weighted input features to generate the spectral nonlocal operator defined in Equation 1. To generate the full-order spectral nonlocal operator (e.g., O ∈R^{W×H×C1}) the example accumulator 230 adds the spectral nonlocal operator with the output of the example full-order spectral nonlocal block 218 (e.g., the Chebyshev approximation graph, O₃ ∈R^{W×H×C1}). The Chebyshev approximation graph is further described below.

When adding into the early stage of a network (e.g., when the features may not be well aggregated), the nonlocal block should have the ability to be consecutively stacked into the network to form a deeper nonlocal structure to exploit the full range dependencies. Accordingly, the example full-order spectral nonlocal block 218 corresponds to the characteristics of steady state when consecutively connecting multiple spectral nonlocal blocks. The example full-order spectral nonlocal block 218 generates an additional term to approximate the full-order Chebyshev polynomials corresponding to a stable hypothesis (e.g., when adding more than two consecutively-connected SNL blocks with the same affinity matrix X into a network structure, the SNL blocks are stable when the variable affinity matrix satisfies A^{k}=A). The example full-order spectral nonlocal block 218 leverages the stable hypothesis to simplify the kth order Chebyshev polynomial (e.g., Tₖ(A)) into a piece-wise function, as shown below in Equation 2.

$${T}_{k} ( A ) = \{ \begin{matrix}I , k \%4 = 0 \\ A , k \%4 = 1 or k \%4 = 3 \\ 2 A - I , k \%4 = 2 \end{matrix} \qquad ( Equation 2 )$$

In Equation 2, I is the identity matrix. Accordingly, the example full-order spectral nonlocal block 218 generates 2A-I (e.g., a Chebyshev approximation matrix) to generate the Chebyshev approximation graph corresponding to a full order spectral nonlocal operator.

The example Chebyshev matrix approximator 220 of FIG. 2 generates the Chebyshev approximation matrix (2A-I) by multiplying the affinity matrix (A) by a scalar (2) and subtracting the identity matrix (I). The example Chebyshev matrix approximator 220 may include a multiplier and a subtractor to generate the Chebyshev approximation matrix. Thus, the example Chebyshev matrix approximator 220 generates the Chebyshev approximation matrix 2A-I ∈R^{WH×WH}. The example Chebyshev matrix approximator 220 outputs the Chebyshev approximation matrix to the example Chebyshev matrix applicator 222.

The example matrix multiplier 224 of the Chebyshev matrix applicator 222 of FIG. 2 multiplies the output of the example reshaper 204 (e.g., the reduced dimension first weighted input features) with the output of the example Chebyshev matrix approximator 220 (e.g., 2A-I) to generate a product. The example reshaper 226 reshapes the product into three dimensions (e.g., (z)(2A−I)∈R^{W×H×C1}). Additionally, the example convolutor 228 of FIG. 2 performs a 1×1 convolution operation using weighted kernels to generate the Chebyshev approximation graph (e.g., O₃ ∈R^{W×H×C1}). To generate the full-order spectral nonlocal operator (e.g., O∈R^{W×H×C1}), the example accumulator 230 adds the spectral nonlocal operator with the output of the example full-order spectral nonlocal block 218 (e.g., the Chebyshev approximation graph, O₃ ∈R^{W×H×C1}). In some examples, the accumulator 230 includes, or is otherwise connected to, the example bin normalizer 231. In such examples, the bin normalize 231 normalizes the sum(s) (e.g., O₁+O₂ or O₁+O₂+O₃) to some fixed range (e.g., [0,1]).

After the full-order spectral nonlocal operator (e.g., O) has been generated, the example accumulator 232 of FIG. 2 applies the full-order spectral nonlocal operator (O) to the input features 200 (X) to generate the example output features 234. For example, the accumulator 232 may add the full-order nonlocal operator (O) to the input features 200 (X) to create the example output features 234. The output features 234 are transmitted to the subsequent component of the neural network 100 (e.g., an additional layer of the feature extractor 105 and/or the classifier 110 (e.g., depending on where the full spectral nonlocal block 107 is implemented in the neural network 100).

While an example manner of implementing the full spectral nonlocal block 107 of FIG. 1 is illustrated in FIG. 2, one or more of the elements, processes and/or devices illustrated in FIG. 2 may be combined, divided, re-arranged, omitted, eliminated and/or implemented in any other way. Further, the example convolutors 202, 216, 228 the example reshapers 204, 214, 226 the example spectral nonlocal block 206, the example affinity matrix generator 208, the example affinity matrix applicator 210, the example multipliers 212, 224, the example full-order spectral nonlocal block 218, the example Chebyshev matrix approximator 220, the example Chebyshev matrix applicator 222, the example accumulators 230, 232, and/or, more generally, the example full spectral nonlocal block 107 of FIG. 2 may be implemented by hardware, software, firmware and/or any combination of hardware, software and/or firmware. Thus, for example, any of the example convolutors 202, 216, 228 the example reshapers 204, 214, 226 the example spectral nonlocal block 206, the example affinity matrix generator 208, the example affinity matrix applicator 210, the example multipliers 212, 224, the example full-order spectral nonlocal block 218, the example Chebyshev matrix approximator 220, the example Chebyshev matrix applicator 222, the example accumulators 230, 232, and/or, more generally, the example full spectral nonlocal block 107 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example convolutors 202, 216, 228 the example reshapers 204, 214, 226 the example spectral nonlocal block 206, the example affinity matrix generator 208, the example affinity matrix applicator 210, the example multipliers 212, 224, the example full-order spectral nonlocal block 218, the example Chebyshev matrix approximator 220, the example Chebyshev matrix applicator 222, the example accumulators 230, 232, and/or, more generally, the example full spectral nonlocal block 107 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example full spectral nonlocal block 107 of FIG. 2 may include one or more elements, processes and/or devices in addition to, or instead of, those illustrated in FIG. 2, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

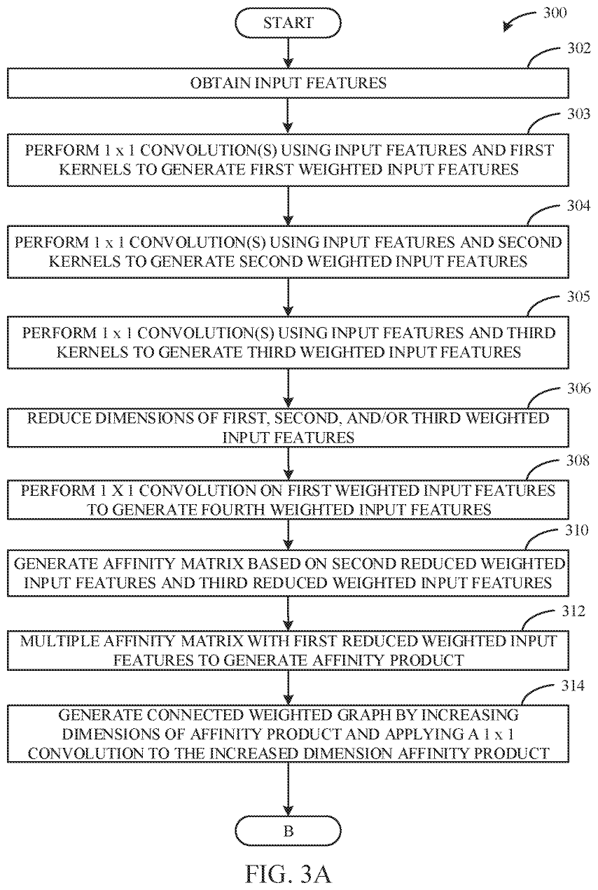

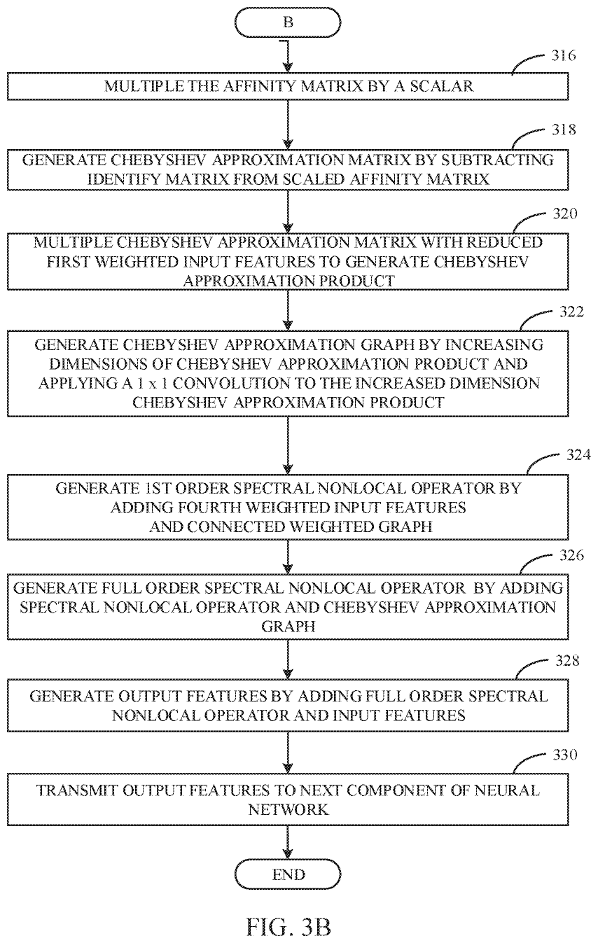

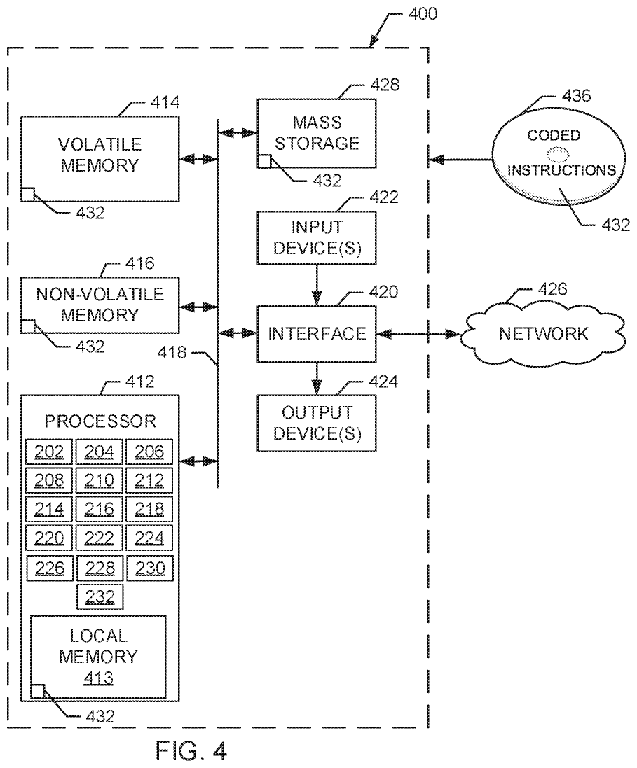

Flowcharts representative of example hardware logic, machine readable instructions, hardware implemented state machines, and/or any combination thereof for implementing the full spectral nonlocal block 107 of FIG. 2 are shown in FIGS. 3A and 3B. The machine readable instructions may be one or more executable programs or portion(s) of an executable program for execution by a computer processor such as the processor 412 shown in the example processor platform 400 discussed below in connection with FIG. 4. The program may be embodied in software stored on a non-transitory computer readable storage medium such as a CD-ROM, a floppy disk, a hard drive, a DVD, a Blu-ray disk, or a memory associated with the processor 412, but the entire program and/or parts thereof could alternatively be executed by a device other than the processor 412 and/or embodied in firmware or dedicated hardware. Further, although the example program is described with reference to the flowchart illustrated in FIGS. 3A and 3B, many other methods of implementing the example full spectral nonlocal block 107 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 2-3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open-ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIGS. 3A and 3B illustrate an example flowchart representative of example machine readable instructions 300 that may be executed by the example full spectral nonlocal block 107 of FIG. 1 to convert input features of a neural network into output features. Although the instructions of FIGS. 3A and 3B are described in conjunction with the example neural network 100 of FIG. 1, the example instructions may be utilized to convert features from any layer of any type of AI-based model.

At block 302, the example convolutor 202 (FIG. 2) and the example affinity matrix generator 208 (FIG. 2) obtain the example input features 200 of FIG. 2. As described above, the example input features 200 are features that have been adjusted from a previous layer of the example feature extractor 105 and/or the output feature matrix 115 of the feature extractor 105. At block 303, the convolutor 202 performs the first 1×1 convolution using the input features 200 and first weighted kernels (e.g., defined during training) to generate the first weighted input features (e.g., Z∈R^{W×H×Cs}). At block 304, the example affinity matrix generator 208 performs the second 1×1 convolution operation using the input features 200 and second weighted kernels (e.g., which are determined during training of the example neural network 100) to generate second weighted input features (e.g., ϕ∈R^{W×H×Cs}). At block 305, the example affinity matrix generator 208 of FIG. 2 performs the third 1×1 convolution operation using weighted kernels (e.g., which are determined during training of the example neural network 100) to generate third weighted input features (e.g., ψ∈R^{W×H×Cs}).

At block 306, the example affinity matrix generator 208 and the example reshaper 204 (FIG. 2) reduce the dimensions of the first, second, and/or third weighted input features. For example, the reshaper 204 converts the three-dimensional first weighted input features into reduced first weighted input features by reducing the dimensions of the three-dimensional first weighted input feature to two dimensions (e.g., z∈R^{WH×Cs}). Additionally, the example affinity matrix generator 208 reshapes the second and third weighted input features into two dimensions (e.g., ϕ∈R^{WH×Cs} and ψ∈R^{WH×Cs}). At block 308, the example convolutor 202 performs a 1×1 convolution using the first weighted input features and third weighted kernels (e.g., defined during training) to generate fourth weighted input features (e.g., O₁∈R^{W×H×C1}).

At block 310, the example affinity matrix generator 208 generates the affinity matrix based on the second reduced weighted input features and the third reduced weighted input features (e.g., ϕ∈R^{WH×Cs} and ψ∈R^{WH×Cs}). For example, the affinity matrix generator 208 reduces the dimensions of the second weighted input features (e.g., ϕ∈R^{W×H×Cs}) and the third weighted input features (e.g., ψ∈R^{W×H×Cs}) from three dimensions to two dimensions (e.g., ϕ∈R^{WH×Cs} and ψ∈R^{WH×Cs}). In this manner, the example affinity matrix generator 208 can calculate the affinity matrix by multiplying the second reduced weighted input features by the transpose of the third reduction weighted input features (e.g., A=(ϕ)(ψ)^{T}). At block 312, the example multiplier 212 (FIG. 2) multiplies the affinity matrix (A) with reduced first weighted input features (z) to generate an affinity product. At block 314, the example affinity matrix applicator 210 (FIG. 2) generates the connected weighted graph by increasing the dimensions (e.g., from two dimensions to three dimensions, (A)(z) ∈R^{WH×Cs}→(A)(z)∈R^{W×H×Cs}) of the affinity product (e.g., using the example reshaper 214 of FIG. 2) and applying a 1×1 convolution (e.g., using the example convolutor 216 of FIG. 2) to the increased dimension affinity product with fifth weighted kernels (e.g., defined during training). The output of the convolutor 216 is the connected weighted graph (e.g., O₂∈R^{W×H×C1}).

At block 316, the example Chebyshev matrix approximator 220 (FIG. 2) multiplies the affinity matrix (A) by a scalar (2). At block 318, the example Chebyshev matrix approximator 220 generates the Chebyshev approximation matrix by subtracting the identity matrix (I) (e.g., having the same dimensions as the scaled affinity matrix) of the same dimensions as the scaled affinity matrix) from the scaled affinity matrix (2A) (e.g., 2A-I). At block 320, the example multiplier 224 (FIG. 2) multiplies the Chebyshev approximation matrix (2A-I) with the reduced first weighted input features (z) to generate a Chebyshev approximation product. At block 322 of FIG. 3B, the example Chebyshev matrix applicator 222 (FIG. 2) generates the Chebyshev approximation graph by increasing the dimensions (e.g., from two dimensions to three dimensions, (2A-1)(z)∈R^{WH×Cs}→(2A-1)(z)∈R^{W×H×Cs}) of the Chebyshev approximation product (e.g., using the example reshaper 226 of FIG. 2) and applying a 1×1 convolution (e.g., using the example convolutor 228 of FIG. 2) to the increased dimension Chebyshev approximation product with sixth weighted kernels (e.g., defined during training). The output of the convolutor 228 is the connected Chebyshev approximation graph (e.g., O₃∈R^{W×H×C1}).

At block 324, the example accumulator 230 (FIG. 2) generates the 1st order spectral nonlocal operator by adding the connected weighted graph (O₂) and the fourth weighted input features (O₁). At block 326, the example accumulator 230 generates the full order spectral nonlocal operator by adding the spectral nonlocal operator (O₁+O₂) and the Chebyshev approximation graph (O₃). At block 328, the example accumulator 232 (FIG. 2) generates the output features 234 by adding the full order spectral nonlocal operator and the input features 200. At block 330, the example accumulator 232 transmits the output features 234 to the next component of the neural network 100 (e.g., a subsequent layer of the feature extractor 105 and/or the classifier 110). In some examples, the bin normalize 231 normalizes the sum(s) to some fixed range (e.g., [0,1]) prior to sending to the accumulator 232. In some examples, when a first order spectral nonlocal operator is used instead of a full order spectral nonlocal, blocks 316-322 and 326 can be removed, and the example accumulator 232 can sum the 1^{st} order spectral nonlocal operator with the input features 200 to generate the output features 234.

FIG. 4 is a block diagram of an example processor platform 400 structured to execute the instructions of FIGS. 3A and 3B to implement the full spectral nonlocal block 107 of FIG. 1. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor 412 may be a semiconductor based (e.g., silicon based) device. In FIG. 4, the example processor 412 implements the example convolutors 202, 216, 228 the example reshapers 204, 214, 226 the example spectral nonlocal block 206, the example affinity matrix generator 208, the example affinity matrix applicator 210, the example multipliers 212, 224, the example full-order spectral nonlocal block 218, the example Chebyshev matrix approximator 220, the example Chebyshev matrix applicator 222, and/or the example accumulators 230, 232 of FIG. 2.

The processor 412 of the illustrated example includes a local memory 413 (e.g., a cache). In FIG. 4, the example local memory 413 implements the example storage device(s) 114. The processor 412 of the illustrated example is in communication with a main memory including a volatile memory 414 and a non-volatile memory 416 via a link 418. The link 418 may be implemented by a bus, one or more point-to-point connections, etc., or a combination thereof. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 400, can allow the user to control the computer system and provide data to the computer using physical gestures, such as, but not limited to, hand or body movements, facial expressions, and face recognition.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives.

Machine executable instructions 432 corresponding to the instructions of FIGS. 3A and 3B may be stored in the mass storage device 428, in the volatile memory 414, in the non-volatile memory 416, in the local memory 413 and/or on a removable non-transitory computer readable storage medium, such as a CD or DVD 436.

Example methods, apparatus, systems, and articles of manufacture to a spectral nonlocal block for a neural network and methods, apparatus, and articles of manufacture to control the same are disclosed herein. Further examples and combinations thereof include the following: Example 1 includes an apparatus comprising a first convolution filter to perform a first convolution using input features and first weighted kernels to generate first weighted input features, the input features corresponding to data input into a neural network, an affinity matrix generator to perform a second convolution using the input features and second weighted kernels to generate second weighted input features, perform a third convolution using the input features and third weighted kernels to generate third weighted input features, and generate an affinity matrix based on the second and third weighted input features, a second convolution filter to perform a fourth convolution using the first weighted input features and fourth weighted kernels to generate fourth weighted input features, a first accumulator to generate a spectral nonlocal operator by adding the fourth weighted input features to a connected weighted graph corresponding to the affinity matrix, and a second accumulator to transmit output features corresponding to the spectral nonlocal operator to a subsequent component of the neural network.

Example 2 includes the apparatus of example 1, wherein the first convolution filter is the second convolution filter.

Example 3 includes the apparatus of example 1, wherein the affinity matrix generator is to generate the affinity matrix by decreasing dimensions of the second weighted input features and the third weighted input features, and multiplying the second weighted input features by a transpose of the third weighted input features.

Example 4 includes the apparatus of example 1, further including a multiplier to multiply the affinity matrix with the first weighted input features to generate an affinity product, the first weighted input features having dimensions reduced prior to the multiplication, a reshaper to increase the dimensions of the affinity product, and a third convolution filter to perform a fifth convolution using the affinity product and fifth weighted kernels to generate the connected weighted graph.

Example 5 includes the apparatus of example 1, wherein the second accumulator is to generate the output features by adding the spectral nonlocal operator and the input features.

Example 6 includes the apparatus of example 1, wherein the apparatus is implemented as a layer in the neural network.

Example 7 includes the apparatus of example 1, wherein the second accumulator is to transmit the output features to a classifier of the neural network.

Example 8 includes the apparatus of example 1, further including a Chebyshev matrix approximator to generate a Chebyshev approximation matrix by multiplying the affinity matrix by a scalar, and subtracting an identity matrix from the scaled affinity matrix.

Example 9 includes the apparatus of example 8, further including a multiplier to multiply the Chebyshev approximation matrix with the first weighted input features to generate a Chebyshev approximation product, the first weighted input features having dimensions reduced prior to the multiplication, a reshaper to increase dimensions of the Chebyshev approximation product, and a third convolution filter to perform a fifth convolution using the Chebyshev approximation product and fifth weighted kernels to generate a Chebyshev approximation graph.

Example 10 includes the apparatus of example 9, wherein the first accumulator is to generate a full order spectral nonlocal operator by adding the spectral nonlocal operator with the Chebyshev approximation graph, the output features corresponding to the full order spectral nonlocal operator.

Example 11 includes a non-transitory computer readable storage medium comprising instructions which, when executed, cause one or more processors to at least perform a first convolution using input features and first weighted kernels to generate first weighted input features, the input features corresponding to data input into a neural network, perform a second convolution using the input features and second weighted kernels to generate second weighted input features, perform a third convolution using the input features and third weighted kernels to generate third weighted input features, and generate an affinity matrix based on the second and third weighted input features, perform a fourth convolution using the first weighted input features and fourth weighted kernels to generate fourth weighted input features, generate a spectral nonlocal operator by adding the fourth weighted input features to a connected weighted graph corresponding to the affinity matrix, and transmit output features corresponding to the spectral nonlocal operator to a subsequent component of the neural network.

Example 12 includes the non-transitory computer readable storage medium of example 11, wherein the instructions cause the one or more processors to generate the affinity matrix by decreasing dimensions of the second weighted input features and the third weighted input features, and multiplying the second weighted input features by a transpose of the third weighted input features.

Example 13 includes the non-transitory computer readable storage medium of example 11, wherein the instructions cause the one or more processors to multiply the affinity matrix with the first weighted input features to generate an affinity product, the first weighted input features having dimensions reduced prior to the multiplication, increase the dimensions of the affinity product, and perform a fifth convolution using the affinity product and fifth weighted kernels to generate the connected weighted graph.

Example 14 includes the non-transitory computer readable storage medium of example 11, wherein the second accumulator is to generate the output features by adding the spectral nonlocal operator and the input features.

Example 15 includes the non-transitory computer readable storage medium of example 11, wherein the one or more processors are implemented as a layer in the neural network.

Example 16 includes the non-transitory computer readable storage medium of example 11, wherein the instructions cause the one or more processors to transmit the output features to a classifier of the neural network.

Example 17 includes the non-transitory computer readable storage medium of example 11, wherein the instructions cause the one or more processors to generate a Chebyshev approximation matrix by multiplying the affinity matrix by a scalar, and subtracting an identity matrix from the scaled affinity matrix.

Example 18 includes the non-transitory computer readable storage medium of example 17, wherein the instructions cause the one or more processors to multiply the Chebyshev approximation matrix with the first weighted input features to generate a Chebyshev approximation product, the first weighted input features having dimensions reduced prior to the multiplication, increase dimensions of the Chebyshev approximation product, and perform a fifth convolution using the Chebyshev approximation product and fifth weighted kernels to generate a Chebyshev approximation graph.

Example 19 includes the non-transitory computer readable storage medium of example 18, wherein the instructions cause the one or more processors to generate a full order spectral nonlocal operator by adding the spectral nonlocal operator with the Chebyshev approximation graph, the output features corresponding to the full order spectral nonlocal operator.

Example 20 includes an apparatus comprising means for performing a first convolution using input features and first weighted kernels to generate first weighted input features, the input features corresponding to data input into a neural network, means for performing a second convolution using the input features and second weighted kernels to generate second weighted input features, the means for performing the second convolution to, perform a third convolution using the input features and third weighted kernels to generate third weighted input features, and generate an affinity matrix based on the second and third weighted input features, means for performing a fourth convolution using the first weighted input features and fourth weighted kernels to generate fourth weighted input features, means for generating a spectral nonlocal operator by adding the fourth weighted input features to a connected weighted graph corresponding to the affinity matrix, and means for transmitting output features corresponding to the spectral nonlocal operator to a subsequent component of the neural network.

Example 21 includes the apparatus of example 20, wherein the means for performing the first convolution is the means for performing the fourth convolution.

Example 22 includes the apparatus of example 20, wherein the means for generating the affinity matrix is to decrease dimensions of the second weighted input features and the third weighted input features, and multiply the second weighted input features by a transpose of the third weighted input features.

Example 23 includes the apparatus of example 20, further including means for multiplying the affinity matrix with the first weighted input features to generate an affinity product, the first weighted input features having dimensions reduced prior to the multiplication, means for increasing the dimensions of the affinity product, and means for performing a fifth convolution using the affinity product and fifth weighted kernels to generate the connected weighted graph.

Example 24 includes the apparatus of example 20, wherein the second accumulator is to generate the output features by adding the spectral nonlocal operator and the input features.

Example 25 includes the apparatus of example 20, wherein the apparatus is implemented as a layer in the neural network.

Example 26 includes the apparatus of example 20, wherein the means for transmitting is to transmit the output features to a classifier of the neural network.

Example 27 includes the apparatus of example 20, further including means for generating a Chebyshev approximation matrix by multiplying the affinity matrix by a scalar, and subtracting an identity matrix from the scaled affinity matrix.

Example 28 includes the apparatus of example 27, further including means for multiplying the Chebyshev approximation matrix with the first weighted input features to generate a Chebyshev approximation product, the first weighted input features having dimensions reduced prior to the multiplication, means for increasing dimensions of the Chebyshev approximation product, and means for performing a fifth convolution using the Chebyshev approximation product and fifth weighted kernels to generate a Chebyshev approximation graph.

Example 29 includes the apparatus of example 28, wherein the means for generating the spectral nonlocal operator is to generate a full order spectral nonlocal operator by adding the spectral nonlocal operator with the Chebyshev approximation graph, the output features corresponding to the full order spectral nonlocal operator.

Example 30 includes a method comprising performing, by executing an instruction using a processor, a first convolution using input features and first weighted kernels to generate first weighted input features, the input features corresponding to data input into a neural network, performing, by executing an instruction with the processor, a second convolution using the input features and second weighted kernels to generate second weighted input features, performing, by executing an instruction with the processor, a third convolution using the input features and third weighted kernels to generate third weighted input features, and generating, by executing an instruction with the processor, an affinity matrix based on the second and third weighted input features, performing, by executing an instruction with the processor, a fourth convolution using the first weighted input features and fourth weighted kernels to generate fourth weighted input features, generating, by executing an instruction with the processor, a spectral nonlocal operator by adding the fourth weighted input features to a connected weighted graph corresponding to the affinity matrix, and transmitting output features corresponding to the spectral nonlocal operator to a subsequent component of the neural network.

Example 31 includes the method of example 30, wherein the generating of the affinity matrix includes decreasing dimensions of the second weighted input features and the third weighted input features, and multiplying the second weighted input features by a transpose of the third weighted input features.

Example 32 includes the method of example 30, further including multiplying the affinity matrix with the first weighted input features to generate an affinity product, the first weighted input features having dimensions reduced prior to the multiplication, increasing the dimensions of the affinity product, and performing a fifth convolution using the affinity product and fifth weighted kernels to generate the connected weighted graph.

Example 33 includes the method of example 30, further including generating the output features by adding the spectral nonlocal operator and the input features.

Example 34 includes the method of example 30, further including transmitting the output features to a classifier of the neural network.

Example 35 includes the method of example 30, further including generating a Chebyshev approximation matrix by multiplying the affinity matrix by a scalar, and subtracting an identity matrix from the scaled affinity matrix.

Example 36 includes the method of example 36, further including multiplying the Chebyshev approximation matrix with the first weighted input features to generate a Chebyshev approximation product, the first weighted input features having dimensions reduced prior to the multiplication, increasing dimensions of the Chebyshev approximation product, and performing a fifth convolution using the Chebyshev approximation product and fifth weighted kernels to generate a Chebyshev approximation graph.

Example 37 includes the method of example 38, further including generating a full order spectral nonlocal operator by adding the spectral nonlocal operator with the Chebyshev approximation graph, the output features corresponding to the full order spectral nonlocal operator.

From the foregoing, it will be appreciated that example technical solutions to a spectral nonlocal block for a neural network and methods, apparatus, and articles of manufacture to control the same have been disclosed. Disclosed examples improve neural network classifications using the disclosed spectral nonlocal block and/or the disclosed full-order spectral nonlocal block. The disclosed spectral nonlocal block and/or the disclosed full-order spectral nonlocal block capture long-range dependencies without diminishing differentiated features due to a damping effect cause by interface between a large number of position pairs. When examples disclosed herein are implemented in a neural network with transferred channels on an image classification data set (e.g., a CIFAR1000 dataset, an ImageNet dataset, etc.), examples disclosed herein correspond to accuracy improvements eight times more than techniques. Likewise, examples disclosed herein correspond to accuracy improvements for the fin-grained image classification dataset (e.g., CUB dataset) and/or an action recognition dataset (e.g., UCF101 dataset). When examples disclosed herein is implemented in a neural network with different positions on a CIFAR1000 Dataset, examples disclosed herein correspond to an accuracy improvements two times more than techniques. Examples disclosed herein further increase accuracy for different network types (e.g., different position 3, same position 2, same position 5) by 2.3-4.7 times more than traditional techniques. Additionally, the computation costs and memory size corresponding to the SNL block disclosed herein are lower or comparable with traditional techniques. Accordingly, disclosed examples are accordingly directed to one or more improvement(s) in the functioning of a neural network.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a first convolution filter to perform a first convolution using input features and first weighted kernels to generate first weighted input features, the input features corresponding to data input into a neural network;
an affinity matrix generator to:
perform a second convolution using the input features and second weighted kernels to generate second weighted input features;
perform a third convolution using the input features and third weighted kernels to generate third weighted input features; and
generate an affinity matrix based on the second and third weighted input features;
a second convolution filter to perform a fourth convolution using the first weighted input features and fourth weighted kernels to generate fourth weighted input features;
a first accumulator to generate a spectral nonlocal operator by adding the fourth weighted input features to a connected weighted graph corresponding to the affinity matrix; and
a second accumulator to transmit output features corresponding to the spectral nonlocal operator to a subsequent component of the neural network.

2. The apparatus of claim 1, wherein the first convolution filter is the second convolution filter.

3. The apparatus of claim 1, wherein the affinity matrix generator is to generate the affinity matrix by:
decreasing dimensions of the second weighted input features and the third weighted input features; and
multiplying the second weighted input features by a transpose of the third weighted input features.

4. The apparatus of claim 1, further including:
a multiplier to multiply the affinity matrix with the first weighted input features to generate an affinity product, the first weighted input features having dimensions reduced prior to the multiplication;
a reshaper to increase the dimensions of the affinity product; and
a third convolution filter to perform a fifth convolution using the affinity product and fifth weighted kernels to generate the connected weighted graph.

5. The apparatus of claim 1, wherein the second accumulator is to generate the output features by adding the spectral nonlocal operator and the input features.

6. The apparatus of claim 1, wherein the apparatus is implemented as a layer in the neural network.

7. The apparatus of claim 1, wherein the second accumulator is to transmit the output features to a classifier of the neural network.

8. The apparatus of claim 1, further including a Chebyshev matrix approximator to generate a Chebyshev approximation matrix by:
multiplying the affinity matrix by a scalar; and
subtracting an identity matrix from the scaled affinity matrix.

9. The apparatus of claim 8, further including:
a multiplier to multiply the Chebyshev approximation matrix with the first weighted input features to generate a Chebyshev approximation product, the first weighted input features having dimensions reduced prior to the multiplication;
a reshaper to increase dimensions of the Chebyshev approximation product; and
a third convolution filter to perform a fifth convolution using the Chebyshev approximation product and fifth weighted kernels to generate a Chebyshev approximation graph.

10. The apparatus of claim 9, wherein the first accumulator is to generate a full order spectral nonlocal operator by adding the spectral nonlocal operator with the Chebyshev approximation graph, the output features corresponding to the full order spectral nonlocal operator.

11. A non-transitory computer readable storage medium comprising instructions which, when executed, cause one or more processors to at least:
perform a first convolution using input features and first weighted kernels to generate first weighted input features, the input features corresponding to data input into a neural network;
perform a second convolution using the input features and second weighted kernels to generate second weighted input features;
perform a third convolution using the input features and third weighted kernels to generate third weighted input features; and
generate an affinity matrix based on the second and third weighted input features;
perform a fourth convolution using the first weighted input features and fourth weighted kernels to generate fourth weighted input features;
generate a spectral nonlocal operator by adding the fourth weighted input features to a connected weighted graph corresponding to the affinity matrix; and
transmit output features corresponding to the spectral nonlocal operator to a subsequent component of the neural network.

12. The non-transitory computer readable storage medium of claim 11, wherein the instructions cause the one or more processors to generate the affinity matrix by:
decreasing dimensions of the second weighted input features and the third weighted input features; and
multiplying the second weighted input features by a transpose of the third weighted input features.

13. The non-transitory computer readable storage medium of claim 11, wherein the instructions cause the one or more processors to:
multiply the affinity matrix with the first weighted input features to generate an affinity product, the first weighted input features having dimensions reduced prior to the multiplication;
increase the dimensions of the affinity product; and
perform a fifth convolution using the affinity product and fifth weighted kernels to generate the connected weighted graph.

14. The non-transitory computer readable storage medium of claim 11, wherein the second accumulator is to generate the output features by adding the spectral nonlocal operator and the input features.

15. The non-transitory computer readable storage medium of claim 11, wherein the one or more processors are implemented as a layer in the neural network.

16. The non-transitory computer readable storage medium of claim 11, wherein the instructions cause the one or more processors to transmit the output features to a classifier of the neural network.

17. The non-transitory computer readable storage medium of claim 11, wherein the instructions cause the one or more processors to generate a Chebyshev approximation matrix by:
multiplying the affinity matrix by a scalar; and
subtracting an identity matrix from the scaled affinity matrix.

18. The non-transitory computer readable storage medium of claim 17, wherein the instructions cause the one or more processors to:
multiply the Chebyshev approximation matrix with the first weighted input features to generate a Chebyshev approximation product, the first weighted input features having dimensions reduced prior to the multiplication;
increase dimensions of the Chebyshev approximation product; and
perform a fifth convolution using the Chebyshev approximation product and fifth weighted kernels to generate a Chebyshev approximation graph.

19. The non-transitory computer readable storage medium of claim 18, wherein the instructions cause the one or more processors to generate a full order spectral nonlocal operator by adding the spectral nonlocal operator with the Chebyshev approximation graph, the output features corresponding to the full order spectral nonlocal operator.

20. A method comprising:
performing, by executing an instruction using a processor, a first convolution using input features and first weighted kernels to generate first weighted input features, the input features corresponding to data input into a neural network;
performing, by executing an instruction with the processor, a second convolution using the input features and second weighted kernels to generate second weighted input features;
performing, by executing an instruction with the processor, a third convolution using the input features and third weighted kernels to generate third weighted input features; and
generating, by executing an instruction with the processor, an affinity matrix based on the second and third weighted input features;
performing, by executing an instruction with the processor, a fourth convolution using the first weighted input features and fourth weighted kernels to generate fourth weighted input features;
generating, by executing an instruction with the processor, a spectral nonlocal operator by adding the fourth weighted input features to a connected weighted graph corresponding to the affinity matrix; and
transmitting output features corresponding to the spectral nonlocal operator to a subsequent component of the neural network.
